(19) United States
(12) Patent Application Publication
(10) Pub. No.: US 2025/0294526 A1
(43) Pub. Date: Sep. 18, 2025

(54) COMMUNICATION METHOD AND APPARATUS, TERMINAL, AND NETWORK DEVICE

(71) Applicant: GUANGDONG OPPO MOBILE TELECOMMUNICATIONS CORP., LTD., Dongguan (CN)

(72) Inventors: Shukun WANG, Dongguan (CN); Weijie XU, Dongguan (CN); Cong SHI, Dongguan (CN)

(21) Appl. No.: 19/220,963

(22) Filed: May 28, 2025

Related U.S. Application Data
(63) Continuation of application No. PCT/CN2022/135318, filed on Nov. 30, 2022.

(51) Int. Cl. H04W 72/02; H04B 7/06; H04W 72/0446

(52) U.S. Cl. CPC H04W 72/02; H04B 7/06952; H04W 72/0446

(57) ABSTRACT

Provided are a communication method and a communication apparatus, a terminal, and a network device. The method includes: a terminal receives a trigger command from a network device, and transmits data to the network device, the trigger command is used to trigger the terminal to report the data. The trigger command is transmitted based on a beam sweeping manner, and/or the data is transmitted based on a first manner and/or a second manner. The first mode is that, after receiving the trigger command, the terminal selects a first time interval from a plurality of time intervals, and transmits the data after a delay of the first time interval. The second mode is that, after receiving the trigger command, the terminal selects a first uplink resource from a plurality of uplink resources, and transmits the data by using the first uplink resource.

### CROSS-REFERENCE TO RELATED APPLICATION

This is a continuation application of International Patent Application No. PCT/CN2022/135318, filed on Nov. 30, 2022, the content of which is hereby incorporated by reference in its entirety.

### BACKGROUND

With the development of the Internet of things technology, there will be an increasing number and variety of terminals connected to networks. In some scenarios, the network side expects the terminals in a specific area to report data, allowing the network side to perform relevant analysis, statistics, and the like for the terminals in the area.

However, due to a large number of terminals, the amount of data transmitted in an uplink direction may surge, which will limit uplink capacity of a system.

### SUMMARY

Embodiments of the present disclosure relate to the technical field of mobile communications, and particularly to a communication method, and a terminal.

A communication method is provided in an embodiment of the present disclosure, and the method includes the following operations.

A terminal receives a trigger command from a network device, and the terminal transmits data to the network device, where the trigger command is used to trigger the terminal to report the data.

The trigger command is transmitted based on a beam sweeping manner, and/or the data is transmitted based on a first manner and/or a second manner. The first manner is that, the terminal, after receiving the trigger command, selects a first time interval from a plurality of time intervals, and transmits the data after a delay of the first time interval; and the second manner is that, the terminal, after receiving the trigger command, selects a first uplink resource from a plurality of uplink resources, and transmits the data by using the first uplink resource.

A communication method is provided in an embodiment of the present disclosure, and the communication method includes the following operations.

A network device transmits a trigger command, and the network device receives data from a terminal, where the trigger command is used to trigger the terminal to report the data.

The trigger command is transmitted based on a beam sweeping manner, and/or the data is transmitted based on a first manner and/or a second manner. The first manner is that, the terminal, after receiving the trigger command, selects a first time interval from a plurality of time intervals, and transmits the data after a delay of the first time interval; and the second manner is that, the terminal, after receiving the trigger command, selects a first uplink resource from a plurality of uplink resources, and transmits the data by using the first uplink resource.

A terminal is provided in an embodiment of the present disclosure, and the terminal includes a processor and a memory. The memory is configured to store a computer program, and the processor is configured to call and run the computer program to perform: receiving a trigger command from a network device, and transmitting data to the network device, the trigger command being used to trigger the terminal to report the data.

The trigger command is transmitted based on a beam sweeping manner, and/or the data is transmitted based on a first manner and/or a second manner, wherein the first manner is that, the terminal, after receiving the trigger command, selects a first time interval from a plurality of time intervals, and transmits the data after a delay of the first time interval; and the second manner is that, the terminal, after receiving the trigger command, selects a first uplink resource from a plurality of uplink resources, and transmits the data by using the first uplink resource.

According to the aforementioned technical solutions, on one hand, the network device transmits the trigger command based on the beam sweeping manner, to enable terminals located in different beam coverage areas to receive the trigger command at different times. Since the trigger command is used to trigger the terminal to report the data, the data reporting of the terminals in different beam coverage areas can be differentiated by the different times, thereby improving uplink capacity. On the other hand, when reporting the data, the terminal reports the data after the delay of the time interval, or the terminal selects the uplink resource, from the plurality of uplink resources, for reporting the data. Therefore, the data reporting of the terminals can be differentiated by the time interval or the uplink resource, thereby improving the uplink capacity.

### BRIEF DESCRIPTION OF THE DRAWINGS

The accompanying drawings, which are illustrated herein, provide further understanding of the present disclosure and constitute a part of the present disclosure. The exemplary embodiments of the present disclosure and their descriptions are used to explain the present disclosure and not to unduly limit the present disclosure. In the drawings:

FIG. 1 is a schematic diagram of zero-power communication provided in an embodiment of the present disclosure.

FIG. 2 is a schematic diagram of power harvesting provided in an embodiment of the present disclosure.

FIG. 3 is a schematic diagram of back scattering communication provided in an embodiment of the present disclosure.

FIG. 4 is a schematic diagram of a circuit for resistive load modulation provided in an embodiment of the present disclosure.

FIG. 5 is a schematic diagram of non return zero coding provided in an embodiment of the present disclosure.

FIG. 6 is a schematic diagram of Manchester coding provided in an embodiment of the present disclosure.

FIG. 7 is a schematic diagram of unipolar return-to-zero coding provided in an embodiment of the present disclosure.

FIG. 8 is a schematic diagram of differential bi-phase coding provided in an embodiment of the present disclosure.

FIG. 9 is a schematic diagram of Miller coding provided in an embodiment of the present disclosure.

FIG. 10 is a schematic flowchart of a communication method provided in an embodiment of the present disclosure.

FIG. 11 is a schematic diagram of beam sweeping provided in an embodiment of the present disclosure.

FIG. 12 is a schematic diagram of uplink resources provided in an embodiment of the present disclosure.

FIG. 13 is a schematic diagram of a resource for transmitting data and a sequence provided in an embodiment of the present disclosure.

FIG. 14 is a first schematic diagram of structural composition of a communication apparatus provided in an embodiment of the present disclosure.

FIG. 15 is a second schematic diagram of structural composition of a communication apparatus provided in an embodiment of the present disclosure.

FIG. 16 is a schematic structural diagram of a communication device provided in an embodiment of the present disclosure.

FIG. 17 is a schematic structural diagram of a chip provided in an embodiment of the present disclosure.

FIG. 18 is a schematic block diagram of a communication system provided in an embodiment of the present disclosure.

### DETAILED DESCRIPTION

For convenience of understanding the technical solutions of the embodiments of the present disclosure, related technologies in the embodiments of the present disclosure are described below. The following related technologies, used as optional solutions, may be combined with the technical solutions of the embodiments of the present disclosure in various ways. Such combinations fall within the scope of protection of the embodiments of the present disclosure.

### Principle of Zero-Power Communication Technology

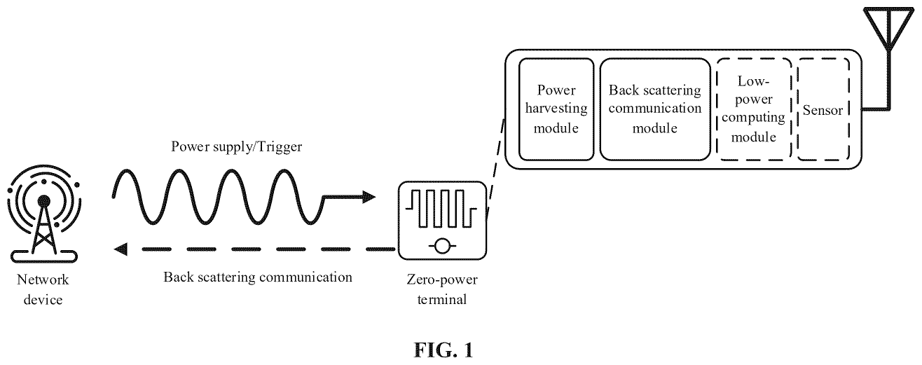

Power harvesting and back scattering communication technologies are utilized in the zero-power communication. As illustrated in FIG. 1, a zero-power communication system includes a network device and a zero-power terminal. The network device is configured to transmit a power supply signal (i.e., a radio wave) and a downlink communication signal to the zero-power terminal, and further receive a back scattering signal from the zero-power terminal. By way of example, the zero-power terminal includes a power harvesting module, a back scattering communication module and a low-power computing module. In addition, the zero-power terminal may also include a memory and/or a sensor. The memory is configured to store some basic information (such as an item identification), and the sensor is configured to obtain sensing data, such as ambient temperature and ambient humidity.

The key technologies of the zero-power communication are further described below.

### (1) Power Harvesting

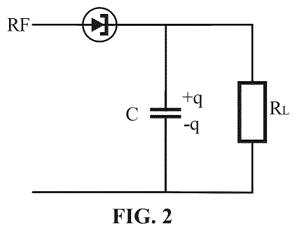

FIG. 2 is a schematic diagram of power harvesting. As illustrated in FIG. 2, the power harvesting module harvests energy of spatial electromagnetic waves based on a principle of electromagnetic induction, to obtain the energy required to drive the zero-power terminal to operate, so as to drive a load circuit (for example, to drive the low-power computing module, the sensor and so on). Therefore, the zero-power terminal does not require a traditional battery, thereby realizing a battery-free communication.

As an example, the power harvesting module refers to a radio-frequency power harvesting module. The radio-frequency power harvesting module may harvest the energy carried by radio waves in space, thereby realizing the energy harvesting of the spatial electromagnetic waves.

### (2) Back Scattering Communication

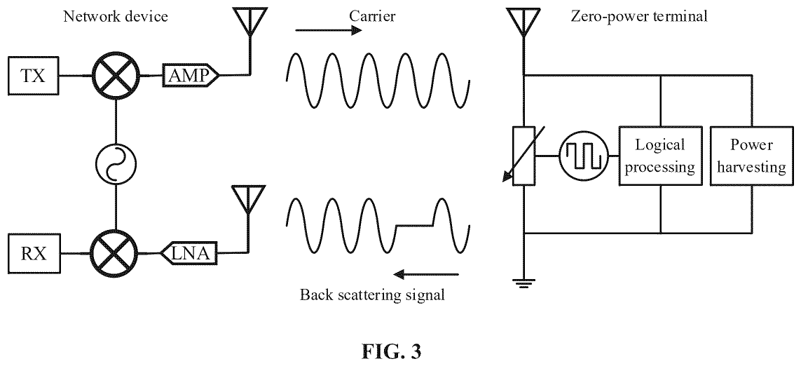

FIG. 3 is a schematic diagram of back scattering communication. As illustrated in FIG. 3, the zero-power terminal receives a wireless signal (i.e., the carrier shown in FIG. 3) transmitted by the network device, modulates the wireless signal (i.e., loading information to be transmitted in the wireless signal), and radiates the modulated signal through an antenna. Such process of information transmission is referred to as the back scattering communication.

The back scattering communication is closely associated with a load modulation function, and the load modulation is a common approach used by the zero-power terminal to load information. In the load modulation, the modulation process is implemented by adjusting and controlling, based on beats of a data stream, a circuit parameter of an oscillation loop of the zero-power terminal, which causes a magnitude and/or a phase of an impedance of the zero-power terminal to be changed accordingly. The load modulation technology mainly includes resistive load modulation and capacitive load modulation.

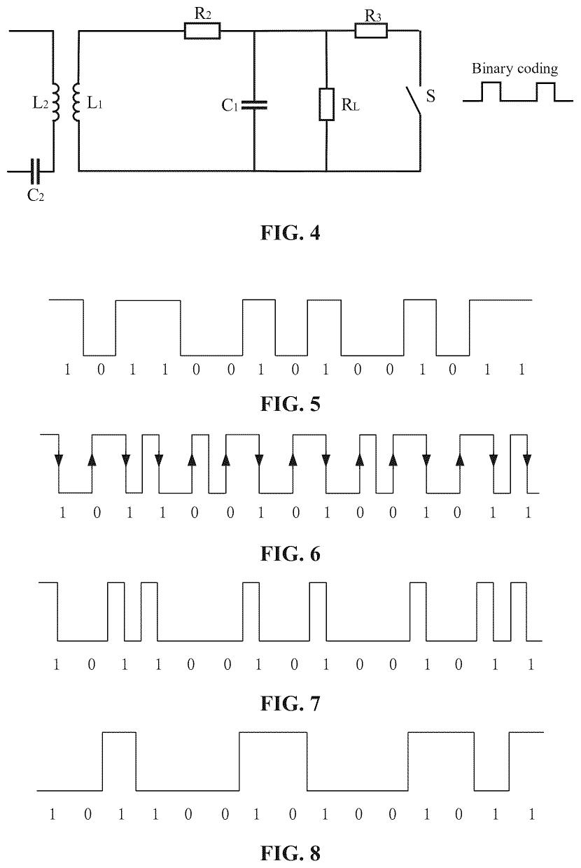

As illustrated in FIG. 4, in the resistive load modulation, a load is connected in parallel with a resistor, which is referred to as a load modulation resistor. The resistor is controlled to be connected or disconnected based on a binary data stream. The connection or disconnection of the resistor may cause a change of a circuit voltage, thereby realizing amplitude shift keying (ASK). That is, the signal modulation is achieved by adjusting the amplitude of the back scattering signal from the zero-power terminal. Similarly, in capacitive load modulation, the load is connected in parallel with a capacitor, which is referred to as a load modulation capacitor. The capacitor replaces the load modulation resistor shown in FIG. 4. The connection or disconnection of the capacitor causes a change in a resonance frequency of the circuit, thereby realizing frequency shift keying (FSK). That is, the signal modulation is achieved by adjusting the operation frequency of the back scattering signal from the zero-power terminal.

Accordingly, the zero-power terminal can implement the back scattering communication process through the information modulation of the received signal by means of the load modulation. As a result, the zero-power terminal has the following significant advantages. On one hand, since the zero-power terminal does not actively transmit a signal, the zero-power terminal does not require a complex radio frequency link, such as a power amplifier, a radio frequency filter, and etc. On the other hand, the zero-power terminal does not need to actively generate a high-frequency signal, and thus does not require a high-frequency crystal oscillator. On yet the other hand, by means of the back scattering communication, the transmission process of the zero-power terminal is not required to consume the energy of the zero-power terminal itself.

### (3) Power Supply Signal and Trigger Signal in Zero-Power Communication System

### Power Supply Signal

The power supply signal is used to provide energy to the zero-power device.

For a carrier of the power supply signal, a transmitting end for the power supply signal may be a base station, an intelligent gateway, a charging station, a micro base station, a smart phone, or the like.

For a frequency band of the power supply signal, the frequency band of a radio wave used by the power supply signal may be a low frequency, an intermediate frequency, a high frequency, or the like.

For a waveform of the power supply signal, the waveform of the radio wave used by the power supply signal may be a sine wave, a square wave, a triangular wave, a pulse wave, a rectangular wave, or the like.

In addition, the power supply signal may be a continuous wave or a discontinuous wave (i.e., with a certain amount of time interruption that is allowed).

The power supply signal may be, but is not limited to, a physical signal specified in the 3rd Generation Partnership Project (3GPP) standard, such as a sounding reference signal (SRS), a physical uplink shared channel (PUSCH), a physical random access channel (PRACH), a physical uplink control channel (PUCCH), a physical downlink control channel (PDCCH), a physical downlink shared channel (PDSCH), a physical broadcast channel (PBCH), or the like. However, the power supply signal, not being limited thereto, may also be a new type of signal.

### Trigger Signal

The trigger signal is used to trigger the communication of the zero-power device, in other words, the trigger signal is used to schedule the zero-power device.

For a carrier of the trigger signal, a transmitting end for the trigger signal may be a base station, an intelligent gateway, a charging station, a micro base station, a smart phone, or the like.

For a frequency band of the trigger signal, the frequency band of a radio wave used by the trigger signal may be a low frequency, an intermediate frequency, a high frequency, or the like.

For a waveform of the trigger signal, the waveform of the radio wave used by the trigger signal may be a sine wave, a square wave, a triangular wave, a pulse wave, a rectangular wave, or the like.

In addition, the trigger signal may be a continuous wave or a discontinuous wave (i.e., with a certain amount of time interruption that is allowed).

The trigger signal may be, but is not limited to, a certain physical signal specified in the 3GPP standard, such as an SRS, a PUSCH, a PRACH, a PUCCH, a PDCCH, a PDSCH, a PBCH, or the like. However, the trigger signal, not being limited thereto, may also be a new type of signal.

### Coding Method of Zero-power Communication

For the data transmitted by the zero-power terminal, different forms of codes may be used to represent binary bits “1” and “0”. Typically, one of the following coding methods may be used by a radio-frequency identification system: non returnzero (NRZ) coding, Manchester coding, unipolar return-to-zero (Unipolar RZ) coding, differential bi-phase (DBP) coding, Miller coding, and differential coding. For the different forms of codes used to represent the binary bits “1” and “0”, it may also be understood that different pulse signals are used to represent the 0 and 1. The several coding methods will be described below.

### (1) NRZ Coding

As illustrated in FIG. 5, in the NRZ coding, a high level represents the binary “1” and a low level represents the binary “0”.

### (2) Manchester Coding

Manchester coding is also known as split-phase coding. In the Manchester coding, the value of a certain bit is represented by a change (rising/falling) of a level at a half bit period within a bit length of the bit. As illustrated in FIG. 6, a negative transition at the half bit period represents the binary “1”, and a positive transition at the half bit period represents the binary “0”.

When applying the load modulation or back scattering modulation on a carrier, the Manchester coding is generally used for data transmission from the zero-power terminal to the network device, which is accordingly conducive to detecting errors in the data transmission. This is because an “unchanged” state is not allowed within the bit length. When data bits transmitted simultaneously by a plurality of zero-power terminals have different values, a rising edge and a falling edge that are received may cancel each other out, resulting in an uninterrupted carrier signal over the entire bit length. Since the unchanged state is not allowed, the network device may use the error to determine the specific location where the collision occurs.

### (3) Unipolar RZ Coding

In the unipolar RZ coding, as illustrated in FIG. 7, a high level in a first half bit period represents the binary “1”, and a low level signal lasting for the entire bit period represents the binary “0”. The unipolar RZ coding may be used to extract a bit synchronization signal.

### (4) Differential Bi-Phase Coding

In the differential bi-phase coding, as illustrated in FIG. 8, any edge in a half bit period represents the binary “0”, and absence of an edge represents the binary “1”. Furthermore, at the beginning of each bit period, the level is inverted. Therefore, for a receiving end, a bit beat is relatively easy to be reconstructed.

### (5) Miller Coding

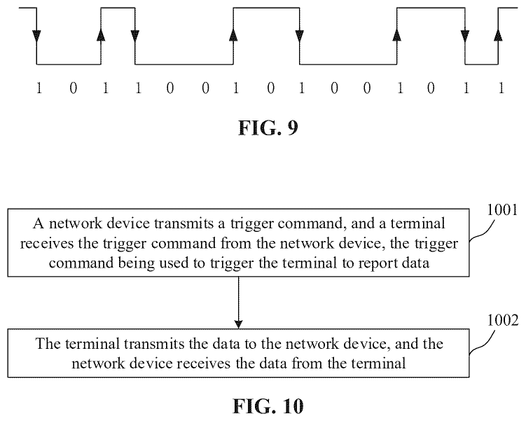

In the Miller coding, as illustrated in FIG. 9, any edge within a half bit period represents the binary “1”, and a level that remains unchanged over a next bit period represents the binary “0”. There is a level alternation at the beginning of the bit period. Therefore, for the receiver, the bit beat is relatively easy to be reconstructed.

### (6) Differential Coding

In the differential coding, each binary “1” to be transmitted causes a change in the signal level, and for the binary “0”, the signal level remains unchanged.

### Classification of Zero-Power Terminals

Based on power sources and usage modes of the zero-power terminals, the zero-power terminals may be classified into the following types.

### (1) Passive Zero-Power Terminal

Such type of zero-power terminal does not require a built-in battery. When the zero-power terminal approaches the network device, the zero-power terminal is in a near-field range formed by antenna radiation of the network device. Therefore, an induced current is generated by the antenna of the zero-power terminal through the electromagnetic induction, and the induced current drives the low-power computing module (i.e., a low-power chip circuit) of the zero-power terminal to operate, thereby realizing demodulation of a forward link signal and modulation of a backward link signal, etc. For the back scattering link, the implementation of back scattering is used by the zero-power terminal for the signal transmission.

Accordingly, whether for the forward link or the reverse link, no built-in battery is needed to drive the passive zero-power terminal, making the passive zero-power terminal to be a true zero-power terminal.

Since the passive zero-power terminal does not require the battery, a radio-frequency circuit and a baseband circuit of the passive zero-power terminal are very simple. For example, a low noise amplifier (LNA), a power amplifier (PA), a crystal oscillator, an analog-to-digital converter (ADC) and the like are not required, so that the passive zero-power terminal has many advantages, such as a small size, a light weight, a low price and a long service life.

### (2) Semi-Passive Zero-Power Terminal

The semi-passive zero-power terminal is not equipped with a conventional battery, but it may use a power harvesting module to harvest the radio wave energy and further store the harvested energy in an energy storage unit (such as a capacitor). After obtaining the energy, the energy storage unit may drive the low-power computing module (i.e., the low-power chip circuit) of the zero-power terminal to operate, thereby realizing the demodulation of the forward link signal and the modulation of the backward link signal, etc. For the back scattering link, the implementation of back scattering is utilized by the zero-power terminal for the signal transmission.

Accordingly, whether for the forward link or the reverse link, no built-in battery is needed to drive the semi-passive zero-power terminal. Although the energy stored in the capacitor is used during the operation of the semi-passive zero-power terminal, the energy is sourced from the energy of the radio waves harvested by the power harvesting module, making the semi-passive zero-power terminal to be a true zero-power terminal.

The semi-passive zero-power terminal inherits many advantages of the passive zero-power terminal, so that the semi-passive zero-power terminal has many advantages, such as a small size, a light weight, a low price and a long service life.

### (3) Active Zero-Power Terminal

In some scenarios, the zero-power terminal that is used may also be the active zero-power terminal, which may include a built-in battery. The battery is used to drive the low-power computing module (i.e., the low-power chip circuit) of the zero-power terminal to operate, thereby realizing the demodulation of the forward link signal and the modulation of the backward link signal, etc. However, for the back scattering link, the implementation of back scattering is utilized by the zero-power terminal for the signal transmission. Therefore, the zero-power consumption of such type of terminal is mainly reflected in the fact that the signal transmission of the reverse link does not require the power of the terminal itself but uses the back scattering manner.

The active zero-power terminal supplies the power to the radio-frequency chip through the built-in battery, thereby increasing a communication range and improving communication reliability. As such, the active zero-power terminal may be applied in some scenarios that require a relatively high requirement in terms of the communication range and communication delay.

### Cellular Passive Internet of Thing (IoT)

With the increasing number of industry applications, the types and application scenarios of connected objects are also growing, which raises higher demands for the price and power consumption of communication terminals. It is a key technology of the cellular IoT to implement applications of battery-free and low-cost passive IoT devices, these devices enrich the types and quantities of the terminals connected to the network, thereby truly realizing the Internet of everything. The passive IoT device may be implemented based on the zero-power communication technology, such as a radio frequency identification (RFID) technology, and may also be extended on such basis, to be suitable for the cellular IoT.

In some scenarios, the network side expects the terminals in a specific area to report data, allowing the network side to relevant analysis, statistics, and the like for the terminals in the area. For example, in a typical application scenario, the zero-power terminals take inventory of logistics and warehousing materials. The network side issues an inventory command, expecting the zero-power terminals in the specific area (such as with the materials in a certain logistics or the materials stored in a certain warehouse) to report the data, such as identification information of the zero-power terminals. However, due to the large number of terminals, the amount of data transmitted in the uplink direction may surge, which will limit the uplink capacity of the system. To address such problems, the solutions of the embodiments of the present disclosure are provided as follows.

It should be noted that the solutions of the embodiments of the present disclosure may be applied to, but is not limited to, an IoT system, a zero-power consumption system, and the like. The “terminal” described in the embodiments of the present disclosure includes, but is not limited to, a zero-power terminal, a passive IoT terminal, and an IoT terminal based on ambient energy.

It should be noted that the “network device” described in the embodiments of the present disclosure may also be replaced with other types of devices.

To facilitate understanding of the technical solutions in the embodiments of the present disclosure, the technical solutions in the present disclosure are described below through the detailed embodiments. The aforementioned related technologies, used as optional solutions, may be combined with the technical solutions of the embodiments of the present disclosure in various ways. Such combinations shall fall within the scope of the protection of the embodiments of the present disclosure. The embodiments of the present disclosure include at least part of the following contents.

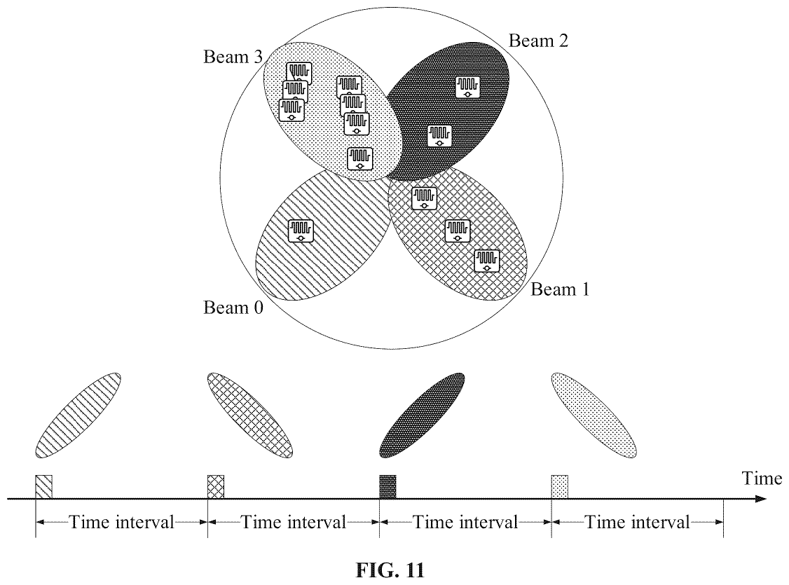

FIG. 10 is a schematic flowchart of a communication method provided in an embodiment of the present disclosure. As illustrated in FIG. 10, the communication method includes the following operations.

At block 1001, a network device transmits a trigger command, and a terminal receives the trigger command from the network device. Herein, the trigger command is used to trigger the terminal to report data.

At block 1002, the terminal transmits the data to the network device, and the network device receives the data from the terminal.

In some implementations, the network device may be an access network device that communicates with the terminal. The access network device may provide communication coverage for a specific area, and may communicate with terminal(s) located within the coverage area. The network device may be a base station, a wireless controller, a relay station, an access point, a vehicle-mounted device, a wearable device, a hub, a switch, a network bridge, a router, a network device in a future evolved public land mobile network (PLMN) or the like.

In embodiments of the present disclosure, the terminal reports the data after receiving the trigger command. In some implementations, different types of trigger commands correspond to different types of data reported by the terminal. For example, the trigger command may be an inventory command, and correspondingly, the type of the data reported by the terminal may include identification information of the terminal and/or position information of the terminal.

In the zero-power communication scenario, the data transmission of the terminal may be implemented based on the back scattering communication. Specifically, after receiving the trigger command, the terminal carries the data to be reported in the trigger command and then performs back scattering on the trigger command.

However, the technical solutions of the embodiments of the present disclosure may be not limited to the zero-power communication scenario, and both the active terminal and the passive terminal are applicable to the technical solutions of the embodiments of the present disclosure.

In embodiments of the present application, in order to improve the uplink capacity, it is necessary to differentiate the data reporting in the uplink direction on different dimensions, which will be described below in conjunction with a first scheme and a second scheme. It is noted that the first scheme and second scheme below may be implemented independently or implemented in combination with each other.

### First Scheme

In some implementations, the trigger command is transmitted based on a beam sweeping manner.

Herein, the network device transmits the trigger command based on the beam sweeping manner, to enable terminals located in different beam coverage areas to receive the trigger command at different times. Since the trigger command is used to trigger the terminal to report the data, the data reporting of the terminals in different beam coverage areas can be differentiated by the different times, thereby improving the uplink capacity.

In some implementations, the trigger command is transmitted on different beams based on a second time interval. Herein, S beams may be achieved in a complete beam sweeping, where S is an integer greater than or equal to 2. The S beams form a burst, and a time interval between two adjacent beams in the burst is the second time interval. The second time interval may be set to be a longer duration, such as a few milliseconds or even tens of milliseconds.

It should be noted that the manner of beam sweeping is a time-division multiplexing manner, that is, different beams are time-division multiplexed.

In some implementations, the trigger command carries a beam index, and the beam index is used to indicate a beam in which the trigger command is located.

For example, four beams may be achieved in the complete beam sweeping by the network device. The network device transmits a trigger command on a beam 0, and the trigger command carries a beam index of the beam 0. After a second time interval, the network device transmits a trigger command on a beam 1, and the trigger command carries a beam index of the beam 1. After another second time interval, the network device transmits a trigger command on a beam 2, and the trigger command carries a beam index of the beam 2. Then, after yet another second time interval, the network device transmits a trigger command on a beam 3, and the trigger command carries a beam index of the beam 3. As such, the complete beam sweeping is finished.

In some implementations, the data carries the beam index, and the beam index is used to indicate the beam in which the terminal is located.

Herein, according to the beam index carried in the trigger command that is received, the terminal may determine the beam index to be carried when reporting the data.

For example, the terminal receives the trigger command that carries the beam index of the beam 2, and the terminal carries and reports the beam index of the beam 2 in the data.

In an example, the network device issues the trigger command based on the beam sweeping manner, to trigger the terminal to report the data of the terminal. A length of a burst in a beam sweeping may be very long, that is, the time interval between two adjacent beams in the burst may be relatively long, such as a few milliseconds or even tens of milliseconds. The network device transmits, based on the time interval, the trigger command in different beam directions, and the beam index may be carried in the trigger command. When the terminal receives the trigger command, the terminal may report the beam index while reporting the data of the terminal, so that the network device can obtain the position information of the terminal. The position information determined based on the beam index may be understood as the position information of a beam granularity. Designing of the total number of beams in a cell or a coverage area as well as the time interval between beams by the network device may depend on the implementation of the network device itself. As illustrated in FIG. 11, the total number of beams is 4, and there is a certain time interval between two adjacent beams. The larger the total number of beams, the higher the time-division multiplexing degree of data reporting among terminals, and the larger the uplink capacity.

### Second Scheme

In some implementations, the data is transmitted based on a first manner and/or a second manner. The first manner is that, the terminal, after receiving the trigger command, selects a first time interval from a plurality of time intervals, and transmits the data after a delay of the first time interval. The second manner is that, the terminal, after receiving the trigger command, selects a first uplink resource from a plurality of uplink resources, and transmits the data by using the first uplink resource.

Herein, when reporting the data, the terminal reports the data after the delay of the time interval, or the terminal selects the uplink resource, from the plurality of uplink resources, for reporting the data. Therefore, the data reporting of the terminals can be differentiated by the time interval or the uplink resource, thereby improving the uplink capacity.

### Regarding the First Manner

After receiving the trigger command, the terminal selects the first time interval from the plurality of time intervals, and further transmits the data after the delay of the first time interval.

In some implementations, the terminal obtains first configuration information, where the first configuration information is used to configure the plurality of time intervals.

In some implementations, the first configuration information is configured by the network device. In such situation, the network device transmits the first configuration information to the terminal, where the first configuration information is used to configure the plurality of time intervals. Here, the first configuration information may be carried in a system broadcast of a cell or in the trigger command.

In some other implementations, the first configuration information is local configuration information of the terminal.

In an embodiment of the present disclosure, the terminal selects the first time interval from the plurality of time intervals through the following options.

Option 1): the terminal selects, based on implementation of the terminal, the first time interval from the plurality of time intervals.

In some implementations, the terminal randomly selects a time interval from the plurality of time intervals as the first time interval.

In some other implementations, the terminal selects, based on an identification of the terminal, a time interval from the plurality of time intervals as the first time interval.

For example, a serial number of the time interval selected by the terminal is ID mod N, where ID is the identification of the terminal, N is the number of the plurality of time intervals, and mod represents a modulo operation. Here, N time intervals are numbered from 0, and the serial numbers of the N time intervals are 0, 1, 2, . . . , N−1 consecutively.

Option 2): the terminal selects, based on an indication from the network device, the first time interval from the plurality of time intervals.

In some implementations, the network device transmits first indication information to the terminal, and the terminal receives the first indication information from the network device. The first indication information is used to indicate the first time interval among the plurality of time intervals. The terminal determines the first time interval based on the first indication information.

For example, when the network device transmits the trigger command to the terminal, the first indication information is carried in the trigger command. After receiving the trigger command, the terminal reports the data after the delay of the time interval, which is indicated by the first indication information.

In the above scheme, after receiving the trigger command, the terminal may report the data to the network device after the delay of the time interval, based on the implementation of the terminal or the indication from the network device. Therefore, the terminals within a coverage area of a beam may further transmit the data in a time-division manner, and thus a collision probability can be reduced and the uplink capacity can be improved.

### Regarding the Second Manner

After receiving the trigger command, the terminal selects the first uplink resource from the plurality of uplink resources, and further transmits the data by using the first uplink resource.

In some implementations, the plurality of uplink resources are a plurality of sub-channels, and the plurality of sub-channels are partitioned from a spectrum supported by a cell in frequency domain.

For a terminal within a coverage area of a beam, one sub-channel may be selected among a plurality of sub-channels in the frequency domain to transmit the data. The plurality of sub-channels are partitioned from the spectrum supported by the cell in the frequency domain.

In some other implementations, the plurality of uplink resources are time-division multiplexed, and/or frequency-division multiplexed, and/or code-division multiplexed, and/or space-division multiplexed.

For the terminal within the coverage area of the beam, one uplink resource may be selected among a plurality of uplink (UL) resources to transmit the data. The plurality of uplink resources are pre-configured, and the plurality of uplink resources are time-division multiplexed, and/or frequency-division multiplexed, and/or code-division multiplexed, and/or space-division multiplexed.

In some implementations, the terminal obtains second configuration information, where the second configuration information is used to configure the plurality of uplink resources.

In some implementations, the second configuration information is configured by the network device. In such situation, the network device transmits the second configuration information to the terminal, where the second configuration information is used to configure the plurality of uplink resources. Here, the second configuration information may be carried in a system broadcast of the cell or in the trigger command.

In some other implementations, the second configuration information is local configuration information of the terminal.

In some implementations, the plurality of uplink resources are distributed in a plurality of uplink resource groups (UL resource bursts/groups), and the plurality of uplink resource groups are distributed periodically.

In some implementations, the second configuration information includes at least one of:
first information, used to determine a period of a plurality of uplink resource groups;
second information, used to determine a number of groups of a plurality of uplink resource groups;
third information, used to determine time-domain information of an uplink resource in an uplink resource group;
fourth information, used to determine frequency-domain information of an uplink resource in an uplink resource group;
fifth information, used to determine code-domain information of an uplink resource in an uplink resource group; or
sixth information, used to determine space-domain information of an uplink resource in an uplink resource group.

Herein, the “uplink resource group” determined according to the third information, the fourth information, the fifth information, or the sixth information may be a first uplink resource group among the plurality of uplink resource groups. Information related to other uplink resource groups may be determined based on the information related to the first uplink resource group and the period. For example, time-domain information of uplink resources in other uplink resource groups may be determined based on time-domain information of the uplink resource in the first uplink resource group and the period. Further, frequency-domain information/code-domain information/space-domain information of the uplink resources in other uplink resource groups may be determined based on frequency-domain information/code-domain information/space-domain information of the uplink resource in the first uplink resource group.

In some implementations, the third information includes at least one of:
a first parameter, used to indicate a time-domain starting position of a first uplink resource in the uplink resource group;
a second parameter, used to indicate a time-domain length of a first uplink resource in the uplink resource group;
a third parameter, used to indicate a time-domain length of an interval between two adjacent uplink resources in time domain of the uplink resource group; or
a fourth parameter, used to indicate a number of uplink resources in time domain of the uplink resource group.

In some implementations, the fourth information includes at least one of:
a fifth parameter, used to indicate a frequency-domain starting position of a first uplink resource in the uplink resource group;
a sixth parameter, used to indicate a frequency-domain length of a first uplink resource in the uplink resource group;
a seventh parameter, used to indicate a frequency-domain length of an interval between two adjacent uplink resources in frequency domain of the uplink resource group; or
an eighth parameter, used to indicate a number of uplink resources in frequency domain of the uplink resource group.

Based on the aforementioned third information and fourth information, a time-frequency position of each uplink resource included in the uplink resource group may be determined.

In some implementations, independent resource index spaces are used by different uplink resource groups in the plurality of uplink resource groups.

For example, there are four uplink resource groups, and each uplink resource group contains six uplink resources. In an uplink resource group 0, the resource indexes of the six uplink resources are 0, 1, 2, 3, 4 and 5, respectively. Similarly, in an uplink resource group 1, the resource indexes of the six uplink resources are 0, 1, 2, 3, 4 and 5, respectively; in an uplink resource group 2, the resource indexes of the six uplink resources are 0, 1, 2, 3, 4 and 5, respectively; and in an uplink resource group 3, the resource indexes of the six uplink resources are 0, 1, 2, 3, 4 and 5, respectively.

In some other implementations, a unified resource index space is used by different uplink resource groups in the plurality of uplink resource groups.

For example, there are four uplink resource groups, and each uplink resource group contains six uplink resources. In an uplink resource group 0, the resource indexes of the six uplink resources are 0, 1, 2, 3, 4 and 5, respectively. In addition, in an uplink resource group 1, the resource indexes of the six uplink resources are 6, 7, 8, 9, 10 and 11, respectively; in an uplink resource group 2, the resource indexes of the six uplink resources are 12, 13, 14, 15, 16 and 17, respectively; and in an uplink resource group 3, the resource indexes of the six uplink resources are 18, 19, 20, 21, 22 and 23, respectively.

In an embodiment of the present disclosure, the terminal may select the first uplink resource from the plurality of uplink resources through the following options.

Option A): the terminal randomly selects an uplink resource from the plurality of uplink resource groups as the first uplink resource.

Option B): the terminal selects, based on an identification of the terminal, an uplink resource from the plurality of uplink resource groups as the first uplink resource.

In some implementations, in a case that the independent resource index spaces are used by different uplink resource groups in the plurality of uplink resource groups, the terminal determines a first resource group index based on the identification of the terminal and a number of groups of the plurality of uplink resource groups, and the terminal determines a first resource index based on the identification of the terminal and a number of uplink resources in an uplink resource group. Further, the terminal determines the first uplink resource based on the first resource group index and the first resource index.

For example, the terminal determines the first resource group index as ID mod M, where ID is the identification of the terminal, M is the number of a plurality of uplink resource groups, and mod represents a modulo operation. Here, M uplink resource groups are numbered from 0. The terminal determines the first resource index as ID mod K, where ID is the identification of the terminal, K is the number of uplink resources included in each uplink resource group, and mod represents a modulo operation. Here, K uplink resources are numbered from 0. Based on the determined first resource group index and the determined first resource index, the terminal may uniquely determine an uplink resource.

In some implementations, in a case that the unified resource index space is used by different uplink resource groups in the plurality of uplink resource groups, the terminal determines a first resource index based on the identification of the terminal and a number of uplink resources in the plurality of uplink resource groups. The terminal determines the first uplink resource based on the first resource index.

For example, the terminal determines the first resource index as ID mod L, where ID is the identification of the terminal, L=M×K, M is the number of groups of the plurality of uplink resource groups, K is the number of uplink resources included in each uplink resource group, and mod represents a modulo operation. Here, L uplink resources are numbered from 0. Based on the determined first resource index, the terminal may uniquely determine an uplink resource.

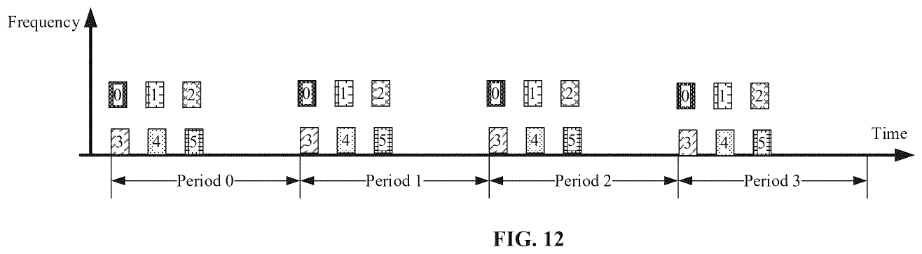

In an example, the network device configures an uplink resource group through a system broadcast of a cell or the trigger command. The uplink resource group includes at least one uplink resource, with the resources being time-division multiplexed and/or frequency-division multiplexed and/or code-division multiplexed and/or space-division multiplexed. The uplink resource groups are periodic, and the network device further configures a period of the uplink resource groups and the number of groups of the uplink resource groups (i.e., how many the uplink resource groups in several periods). The configuration of the uplink resource group includes configuration of at least one of: time-domain information, frequency-domain information, code-domain information, or space-domain information of the uplink resource. Herein, the time-domain information includes, for example, a parameter of a time-domain length of the uplink resource and a parameter for determining a time-domain starting position of the uplink resource. The frequency domain information includes, for example, a parameter of a frequency-domain width of the uplink resource and a parameter for determining a frequency-domain starting position of the uplink resource. Additionally, the configuration of the uplink resource group may further include the data processing method corresponding to the uplink resource group, such as an on-off keying (OOK) or an FSK. The parameter for determining the time-domain starting position of the uplink resource may be an offset between the time-domain starting position of the first uplink resource in the uplink resource group and a time-domain position at which the configuration information is received. As illustrated in FIG. 12, there are four uplink resource groups, and each uplink resource group contains six uplink resources. In FIG. 12, the independent resource index spaces are used by different uplink resource groups in the plurality of uplink resource groups as an example. The terminal may select one uplink resource from the four uplink resource groups to transmit the data. The uplink resource is selected through the following selection manners.

The terminal randomly selects an uplink resource from the four uplink resource groups. For example, there are a total of twenty-four uplink resources in the four uplink resource groups, and the terminal randomly may select an uplink resource from the twenty-four uplink resources to transmit the data.

The terminal determines an uplink resource based on calculation. For example, in the case that the independent resource index spaces are used by different uplink resource groups, a group index of a target uplink resource group may be calculated by ID mod 4, and a resource index of a target uplink resource in the target uplink resource group may be calculated by ID mod 6. Then, the uplink resource may be determined uniquely based on the group index and the resource index that are calculated. For another example, in the case that the unified resource index space is used by different uplink resource groups, a resource index of a target uplink resource may be calculated by ID mod 24, and then the uplink resource may be determined uniquely based on the resource index that is calculated.

The aforementioned first scheme and second scheme may be implemented independently or implemented in combination with each other. When the aforementioned first scheme and the second scheme are implemented in combination with each other, the second scheme may be applied to each beam in the first scheme. That is, according to the second scheme, a plurality of time intervals or a plurality of uplink resources may be configured for each beam direction.

### Third Scheme

In some implementations, each data transmitted by the terminal is associated with a sequence, and the data that is associated with the sequence may be identified based on the sequence.

In some implementations, the first uplink resource includes a first portion and a second portion. The first portion is used to transmit a first sequence, and the second portion is used to transmit the data. Herein, the first sequence is the sequence associated with the data.

In some other implementations, the first uplink resource has an association relationship with a first associated resource. The first associated resource is used to transmit the first sequence, and the first uplink resource is used to transmit the data. Herein, the first sequence is the sequence associated with the data.

In some implementations, the network device transmits third configuration information to the terminal, and the terminal obtains the third configuration information. The third configuration information is used to configure a sequence at a cell level or configuring a sequence at a beam level. Herein, the third configuration information may be carried in the system broadcast of the cell or in the trigger command.

In some implementations, in a case that the third configuration information is used to configure the sequence at the beam level, different beam indexes are associated with different sequence ranges. In such situation, the terminal selects, based on a beam index carried in the trigger command and the third configuration information, the first sequence from a sequence range associated with the beam index.

For example, a cell has four beams: beam 0 is associated with a sequence range 0, beam 1 is associated with a sequence range 1, beam 2 is associated with a sequence range 2, and beam 3 is associated with a sequence range 3. The terminal receives the trigger command which carries a beam index of the beam 1. Then, the terminal selects a sequence from the sequence range 1, transmits the sequence through the first portion of the first uplink resource that is selected, and further transmits the data through the second portion of the first uplink resource. Alternatively, the terminal transmits the data through the first uplink resource, and further transmits the sequence through a first associated resource which is associated with the first uplink resource.

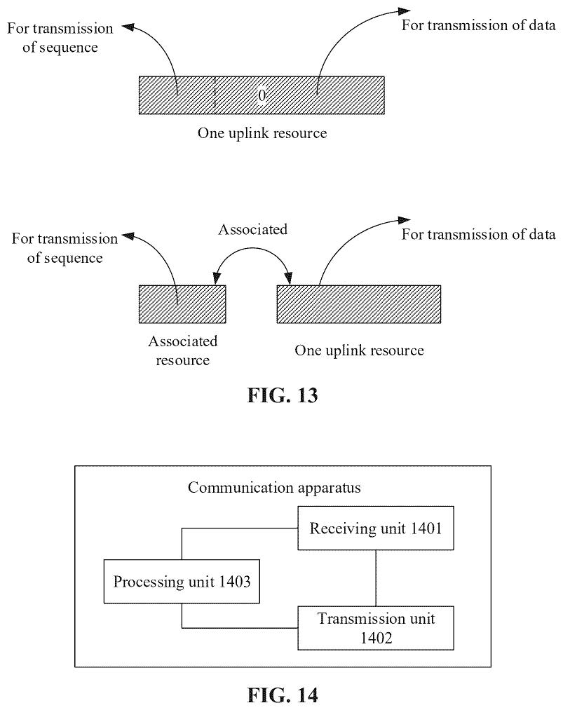

In an example, as illustrated in FIG. 13, while the terminal transmits the data on the uplink resource that is selected, the terminal may simultaneously transmit the sequence on a wireless resource (referred to as the associated resource) associated with the uplink resource. Alternatively, the uplink resource includes two portions: one for transmitting the sequence and the other one for transmitting the data.

In some implementations, when the terminal determines that reception of the data fails, the terminal retransmits the data to the network device. In an option I), the terminal receives a failure reception response message from the network device, where the failure reception response message is used to indicate a sequence index corresponding to the data that is failed to be received. The terminal determines that the reception of the data fails based on the failure reception response message. In an option II), when the terminal does not receive the response message of the data from the network device during a first period, the terminal determines that the reception of the data fails. Herein, the first period is a running period of a first timer, and a starting time of the first timer is determined based on a time for transmitting the data.

For the above option I), correspondingly, when the network device fails to receive the data, the network device transmits the failure reception response message to the terminal, where the failure reception response message is used to indicate a sequence index corresponding to the data that is failed to be received.

In the above scheme, if the network device fails to receive the data (e.g., failing to decode the uplink data or not receiving the uplink data), the network device may transmit the failure reception response message, to indicate the sequence index corresponding to the data that is failed to be received. For the terminal that selects the sequence corresponding to the sequence index, the data is required to be retransmitted. In the zero-power communication scenario, the downlink transmission for the back scattering communication of the retransmitted data may be based on the failure reception response message transmitted by the network device. Alternatively, if the network device fails to decode the data, the terminal may not receive a response message (i.e., feedback) for the data from the network device. Then, the terminal determines that the reception of the data fails, allowing the terminal to retransmit the data. The uplink resource used for retransmission may be the same as the uplink resource previously used to transmit the data; or, an uplink resource, different from the uplink resource that is previously used to transmit the data, may be reselected based on the second scheme mentioned above.

### Fourth Scheme

In some implementations, the network device determines, through a sensing communication, a number of terminals within a coverage area of a cell and/or a number of terminals within a coverage area of each beam of a cell. Additionally, the network device performs, based on the number of terminals and an amount of received data, at least one of:
determination of whether to initiate a next new trigger command;
determination of whether to retransmit the trigger command; or
determination of whether to release the plurality of uplink resources.

For example, when a difference between the number of terminals and the amount of data received by the network device is less than or equal to a threshold, the network device may determine to initiate the next new trigger command and/or to release the plurality of uplink resources that are pre-configured. When the difference between the number of terminals and the amount of data received by the network device is larger than or equal to the threshold, the network device may determine to retransmit the trigger command and/or to reserve the plurality of uplink resources that are pre-configured.

In some implementations, the network device transmits a sensing signal and receives a reflected sensing signal. The network device determines, based on the reflected sensing signal, the number of terminals within the coverage area of the cell and/or the number of terminals within the coverage area of each beam of the cell.

In some other implementations, the network device transmits a sensing request to a third party node, where the sensing request is used to request the third party node to perform the sensing communication to determine the number of terminals within the coverage area of the cell and/or the number of terminals within the coverage area of each beam of the cell. The network device receives a sensing result from the third party node, and further determines, based on the sensing result, the number of terminals within the coverage area of the cell and/or the number of terminals within the coverage area of each beam of the cell.

In the above scheme, since the network device does not know how many terminals are in the network coverage area and which terminals are in the network coverage area, after transmitting the data request or the trigger command, the network device does not know whether all terminals (i.e., the terminals that need to be inventoried) in the coverage area have completed the data reporting, or whether there is any terminal failed to complete the data reporting due to being damaged, or whether the poor downlink or uplink coverage causes the terminal to fail to complete the data reporting. To solve such problem, the network device obtains the number of terminals that need to be inventoried in the network coverage area through the sensing communication. This can assist the network device in determining whether to initiate the next data request or inventory round after completing a round of data request or inventory, or assist the network device in determining whether the pre-configured uplink resource can be released (i.e., recovered). Thus, the terminal that misses the data reporting or fails to report the data may have an opportunity to report the data again, and can also assist the network device in detecting the damaged terminal.

According to the technical solution in the embodiments of the present disclosure, on one hand, the network device transmits the trigger command based on the beam sweeping manner, which enables the terminals located in different beam coverage areas to receive the trigger command at different times. In addition, since the trigger command is used to trigger the terminal to report the data, the data reporting by the terminals in different beam coverage areas can be differentiated by the different times, thereby improving the uplink capacity. On the other hand, when reporting the data, the terminal reports the data after the delay of the time interval or the terminal selects the uplink resource, from the plurality of uplink resources, for reporting the data. Therefore, the data reporting by the terminals can be differentiated by the time intervals or the uplink resources, thereby improving the uplink capacity. In addition, the present disclosure also provides the solutions for how the terminal determines whether to initiate the retransmission and how the network device determines, based on the sensing communication, whether to release the pre-configured uplink resource. As such, the resources can be saved and the spectrum efficiency of the uplink resources can be improved.

Preferred embodiments of the present disclosure have been described in detail above with reference to the accompanying drawings. However, the present disclosure is not limited to the specific details of the aforementioned implementations. Within the scope of the technical conception of the present disclosure, a variety of simple variations can be made to the technical solutions of the present disclosure, and such simple variations shall fall within the scope of protection of the present disclosure. For example, various specific technical features described in the aforementioned specific embodiments may be combined in any suitable manner without contradiction, and various possible combinations are not further described in the present disclosure in order to avoid unnecessary repetition. For another example, any combination may be made between various implementations of the present disclosure, as long as it does not depart from the idea of the present disclosure, and is likewise to be regarded as the contents of the present disclosure. For another example, on the premise of no conflict, various embodiments described in the present disclosure and/or the technical features in the various embodiments can be combined with the related art at will. The technical solutions obtained after the combination shall also fall within the scope of protection of the present disclosure.

It should be understood that, in various method embodiments of the present disclosure, the size of the sequence number of the aforementioned processes does not imply the order of execution. The execution order of the processes shall be determined by functions thereof and inherent logic, which shall not constitute any limitation on the implementation processes of the embodiments of the present disclosure. Furthermore, in the embodiments of the present disclosure, the terms “downlink”, “uplink” and “sidelink” each is used to represent a transmission direction of a signal or data. Herein, the term “downlink” represents that the transmission direction of the signal or data is a first direction transmitted from a site to a user device in a cell, the term “uplink” represents that the transmission direction of the signal or data is a second direction transmitted from the user device in the cell to the site, and the term “sidelink” represents that the transmission direction of the signal or data is a third direction transmitted from a user device 1 to a user device 2. For example, a “downlink signal” represents that the signal is transmitted in the first direction. In addition, in the embodiments of the present disclosure, the term “and/or” herein is only used to describe an association relationship between associated objects, and represents that three kinds of relationships may exist. Specifically, “A and/or B” may represent three conditions: i.e., independent existence of A, existence of both A and B, and independent existence of B. Additionally, the character “/” herein usually represents that previous and next associated objects form an “or” relationship.

FIG. 14 is a first schematic diagram of structural composition of a communication apparatus provided in an embodiment of the present disclosure. The communication apparatus is applied to a terminal, and as illustrated in FIG. 14, the communication apparatus includes a receiving unit 1401 and a transmission unit 1402.

The receiving unit 1401 is configured to receive a trigger command from a network device, where the trigger command is used to trigger the terminal to report data.

The transmission unit 1402 is configured to transmit the data to the network device.

The trigger command is transmitted based on a beam sweeping manner, and/or, the data is transmitted based on a first manner and/or a second manner. Here, the first manner is that, the terminal, after receiving the trigger command, selects a first time interval from a plurality of time intervals, and transmits the data after a delay of the first time interval; and the second manner is that, the terminal, after receiving the trigger command, selects a first uplink resource from a plurality of uplink resources, and transmits the data by using the first uplink resource.

In some implementations, the trigger command is transmitted on different beams based on a second time interval.

In some implementations, the trigger command carries a beam index, and the beam index is used to indicate a beam in which the trigger command is located.

In some implementations, the data carries the beam index, and the beam index is used to indicate the beam in which the terminal is located.

In some implementations, the apparatus further includes an obtaining unit. The obtaining unit is configured to obtain first configuration information, and the first configuration information is used to configure the plurality of time intervals.

In some implementations, the first configuration information is configured by the network device; or the first configuration information is local configuration information of the terminal.

In some implementations, the apparatus further includes a processing unit 1403. The processing unit 1403 is configured to: select, based on implementation of the terminal, the first time interval from the plurality of time intervals; or select, based on an indication from the network device, the first time interval from the plurality of time intervals.

In some implementations, the processing unit 1403 is configured to: randomly select a time interval from the plurality of time intervals as the first time interval; or select, based on an identification of the terminal, a time interval from the plurality of time intervals as the first time interval.

In some implementations, the receiving unit 1401 is configured to: receive first indication information from the network device, where the first indication information is used to indicate the first time interval among the plurality of time intervals. Additionally, the processing unit 1403 is configured to determine the first time interval based on the first indication information.

In some implementations, the plurality of uplink resources are a plurality of sub-channels, and the plurality of sub-channels are partitioned from a spectrum supported by a cell in frequency domain.

In some implementations, the plurality of uplink resources are time-division multiplexed, and/or frequency-division multiplexed, and/or code-division multiplexed, and/or space-division multiplexed.

In some implementations, the apparatus further includes an obtaining unit. The obtaining unit is configured to obtain second configuration information, and the second configuration information is used to configure the plurality of uplink resources.

In some implementations, the second configuration information is configured by the network device; or the second configuration information is local configuration information of the terminal.

In some implementations, the plurality of uplink resources are distributed in a plurality of uplink resource groups, and the plurality of uplink resource groups are distributed periodically.

In some implementations, the second configuration information includes at least one of:
first information, used to determine a period of a plurality of uplink resource groups;
second information, used to determine a number of groups of a plurality of uplink resource groups;
third information, used to determine time-domain information of an uplink resource in an uplink resource group;
fourth information, used to determine frequency-domain information of an uplink resource in an uplink resource group;
fifth information, used to determine code-domain information of an uplink resource in an uplink resource group; or
sixth information, used to determine space-domain information of an uplink resource in an uplink resource group.

In some implementations, the third information includes at least one of:
a first parameter, used to indicate a time-domain starting position of a first uplink resource in the uplink resource group;
a second parameter, used to indicate a time-domain length of a first uplink resource in the uplink resource group;
a third parameter, used to indicate a time-domain length of an interval between two adjacent uplink resources in time domain of the uplink resource group; or
a fourth parameter, used to indicate a number of uplink resources in time domain of the uplink resource group.

In some implementations, the fourth information includes at least one of:
a fifth parameter, used to indicate a frequency-domain starting position of a first uplink resource in the uplink resource group;
a sixth parameter, used to indicate a frequency-domain length of a first uplink resource in the uplink resource group;
a seventh parameter, used to indicate a frequency-domain length of an interval between two adjacent uplink resources in frequency domain of the uplink resource group; or
an eighth parameter, used to indicate a number of uplink resources in frequency domain of the uplink resource group.

In some implementations, independent resource index spaces are used by different uplink resource groups in the plurality of uplink resource groups; or a unified resource index space is used by different uplink resource groups in the plurality of uplink resource groups.

In some implementations, the processing unit 1403 is configured to: randomly select an uplink resource from the plurality of uplink resource groups as the first uplink resource; or select, based on an identification of the terminal, an uplink resource from the plurality of uplink resource groups as the first uplink resource.

In some implementations, in a case that the independent resource index spaces are used by different uplink resource groups in the plurality of uplink resource groups, the processing unit 1403 is configured to: determine a first resource group index based on the identification of the terminal and a number of groups of the plurality of uplink resource groups, and determine a first resource index based on the identification of the terminal and a number of uplink resources in an uplink resource group; and determine the first uplink resource based on the first resource group index and the first resource index.

In some implementations, in a case that the unified resource index space is used by different uplink resource groups in the plurality of uplink resource groups, the processing unit 1403 is configured to: determine a first resource index based on the identification of the terminal and a number of resources in the plurality of uplink resource groups; and determine the first uplink resource based on the first resource index.

In some implementations, the first uplink resource includes a first portion and a second portion, where the first portion is used to transmit a first sequence, and the second portion is used to transmit the data. Or, the first uplink resource has an association relationship with a first associated resource, where the first associated resource is used to transmit a first sequence, and the first uplink resource is used to transmit the data.

In some implementations, the apparatus further includes an obtaining unit. The obtaining unit is configured to obtain third configuration information, and the third configuration information is used to configure a sequence at a cell level or configuring a sequence at a beam level.

In some implementations, in a case that the third configuration information is used to configure the sequence at the beam level, different beam indexes are associated with different sequence ranges.

In some implementations, the processing unit 1403 is configured to select, based on a beam index carried in the trigger command and the third configuration information, the first sequence from a sequence range associated with the beam index.

In some implementations, the transmission unit 1402 is configured to: when determining that reception of the data fails, retransmit the data to the network device.

In some implementations, the receiving unit 1401 is configured to receive a failure reception response message from the network device, where the failure reception response message is used to indicate a sequence index corresponding to the data that is failed to be received. Additionally, the processing unit 1403 is configured to determine that the reception of the data fails based on the failure reception response message.

In some implementations, the processing unit 1403 is configured to, when not receiving a response message of the data by the receiving unit 1401 from the network device during a first period, determine that the reception of the data fails.

In some implementations, the first period is a running period of a first timer, and a starting time of the first timer is determined based on a time for transmitting the data.

In some implementations, the terminal is a zero-power terminal, or a passive Internet of things terminal, or an Internet of things terminal based on ambient energy.

It should be understood by those skilled in the art that the relevant descriptions of the aforementioned apparatus for communication in the embodiments of the present disclosure may be understood with reference to relevant descriptions of the method for communication in the embodiments of the present disclosure.

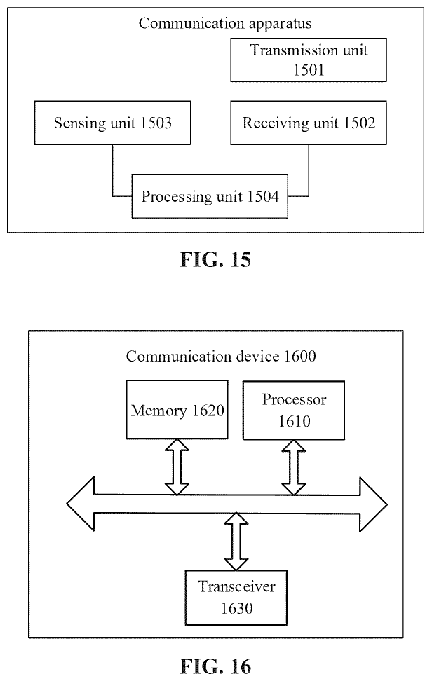

FIG. 15 is a second schematic diagram of structural composition of a communication apparatus provided in an embodiment of the present disclosure. The communication apparatus is applied to a network device, and as illustrated in FIG. 15, the communication apparatus includes a transmission unit 1501 and a receiving unit 1502.

The transmission unit 1501 is configured to transmit a trigger command for triggering a terminal to report data.

The receiving unit 1502 is configured to receive the data from the terminal.

The trigger command is transmitted based on a beam sweeping manner, and/or the data is transmitted based on a first manner and/or a second manner. Here, the first manner is that, the terminal, after receiving the trigger command, selects a first time interval from a plurality of time intervals, and transmits the data after a delay of the first time interval; and the second manner is that, the terminal, after receiving the trigger command, selects a first uplink resource from a plurality of uplink resources, and transmits the data by using the first uplink resource.

In some implementations, the trigger command is transmitted on different beams based on a second time interval.

In some implementations, the trigger command carries a beam index, and the beam index is used to indicate a beam in which the trigger command is located.

In some implementations, the data carries the beam index, and the beam index is used to indicate a beam in which the terminal is located.

In some implementations, the transmission unit 1501 is configured to transmit first configuration information to the terminal, where the first configuration information is used to configure the plurality of time intervals.

In some implementations, the transmission unit 1501 is configured to transmit first indication information to the terminal, where the first indication information is used to indicate the first time interval among the plurality of time intervals.

In some implementations, the plurality of uplink resources are a plurality of sub-channels, and the plurality of sub-channels are partitioned from a spectrum supported by a cell in frequency domain.

In some implementations, the plurality of uplink resources are time-division multiplexed, and/or frequency-division multiplexed, and/or code-division multiplexed, and/or space-division multiplexed.

In some implementations, the transmission unit 1501 is configured to transmit second configuration information to the terminal, where the second configuration information is used to configure the plurality of uplink resources.

In some implementations, the plurality of uplink resources are distributed in a plurality of uplink resource groups, and the plurality of uplink resource groups are distributed periodically.

In some implementations, the second configuration information includes at least one of:
first information, used to determine a period of a plurality of uplink resource groups;
second information, used to determine a number of groups of a plurality of uplink resource groups;
third information, used to determine time-domain information of an uplink resource in an uplink resource group;
fourth information, used to determine frequency-domain information of an uplink resource in an uplink resource group;
fifth information, used to determine code-domain information of an uplink resource in an uplink resource group; or
sixth information, used to determine space-domain information of an uplink resource in an uplink resource group.

In some implementations, the third information includes at least one of:
a first parameter, used to indicate a time-domain starting position of a first uplink resource in the uplink resource group;
a second parameter, used to indicate a time-domain length of a first uplink resource in the uplink resource group;
a third parameter, used to indicate a time-domain length of an interval between two adjacent uplink resources in time domain of the uplink resource group; or
a fourth parameter, used to indicate a number of uplink resources in time domain of the uplink resource group.

In some implementations, the fourth information includes at least one of:
a fifth parameter, used to indicate a frequency-domain starting position of a first uplink resource in the uplink resource group;
a sixth parameter, used to indicate a frequency-domain length of a first uplink resource in the uplink resource group;
a seventh parameter, used to indicate a frequency-domain length of an interval between two adjacent uplink resources in frequency domain of the uplink resource group; or
an eighth parameter, used to indicate a number of uplink resources in frequency domain of the uplink resource group.

In some implementations, independent resource index spaces are used by different uplink resource groups in the plurality of uplink resource groups; or a unified resource index space is used by different uplink resource groups in the plurality of uplink resource groups.

In some implementations, the first uplink resource includes a first portion and a second portion, where the first portion is used to transmit a first sequence, and the second portion is used to transmit the data. Or, the first uplink resource has an association relationship with a first associated resource, where the first associated resource is used to transmit a first sequence, and the first uplink resource is used to transmit the data.

In some implementations, the transmission unit 1501 is configured to transmit third configuration information to the terminal, where the third configuration information is used to configure a sequence at a cell level or configuring a sequence at a beam level.

In some implementations, in a case that the third configuration information is used to configure the sequence at the beam level, different beam indexes are associated with different sequence ranges.

In some implementations, the transmission unit 1501 is configured to, when the receiving unit 1502 failing to receive the data, transmit a failure reception response message to the terminal. Here, the failure reception response message is used to indicate a sequence index corresponding to the data that is failed to be received.

In some implementations, the terminal is a zero-power terminal, or a passive Internet of things terminal, or an Internet of things terminal based on ambient energy.

In some implementations, the apparatus further includes a sensing unit 1503 and a processing unit 1504. The sensing unit 1503 is configured to determine, through a sensing communication, a number of terminals within a coverage area of a cell and/or a number of terminals within a coverage area of each beam of a cell. The processing unit 1504 is configured to perform, based on the number of terminals and an amount of received data, at least one of:
determination of whether to initiate a next new trigger command;
determination of whether to retransmit the trigger command; or
determination of whether to release the plurality of uplink resources.

In some implementations, the sensing unit 1503 is configured to: transmit a sensing signal, receive a reflected sensing signal, and determine, based on the reflected sensing signal, the number of terminals within the coverage area of the cell and/or the number of terminals within the coverage area of each beam of the cell.

In some other implementations, the sensing unit 1503 is configured to transmit a sensing request to a third party node, where the sensing request is used to request the third party node to perform the sensing communication to determine the number of terminals within the coverage area of the cell and/or the number of terminals within the coverage area of each beam of the cell. In addition, the sensing unit 1503 is further configured to receive a sensing result from the third party node, and determine, based on the sensing result, the number of terminals within the coverage area of the cell and/or the number of terminals within the coverage area of each beam of the cell.

It should be understood by those skilled in the art that the relevant descriptions of the aforementioned communication apparatuses in the embodiments of the present disclosure may be understood with reference to the relevant descriptions of the communication methods in the embodiments of the present disclosure.

FIG. 16 is a schematic structural diagram of a communication device 1600 according to an embodiment of the present disclosure. The communication device may be a terminal or a network device. The communication device 1600 illustrated in FIG. 16 includes a processor 1610. The processor 1610 may be configured to call a computer program stored in a memory and run the computer program to perform each of the methods according to the embodiments of the present disclosure.

Optionally, as illustrated in FIG. 16, the communication device 1600 may further include a memory 1620. Herein, the processor 1610 may be configured to call the computer program from the memory 1620, and run the computer program to perform each of the methods according to the embodiments of the present disclosure.

Herein, the memory 1620 may be a separate device independent of the processor 1610, or may be integrated into the processor 1610.

Optionally, as illustrated in FIG. 16, the communication device 1600 may further include a transceiver 1630. The processor 1610 may control the transceiver 1630 to communicate with other devices, specifically, to transmit information or data to other devices, or receive information or data from other devices.

Herein, the transceiver 1630 may include a transmitter and a receiver. The transceiver 1630 may further include one or more antennas.

Optionally, the communication device 1600 may specifically be the network device in the embodiments of the present disclosure. The communication device 1600 may perform the corresponding process implemented by the network device in each of the methods in the embodiments of the present disclosure. For brevity, details are not elaborated herein again.

Optionally, the communication device 1600 may specifically be a mobile terminal/terminal in the embodiments of the present disclosure. The communication device 1600 may perform the corresponding process implemented by the mobile terminal/terminal in each of the methods in the embodiments of the present disclosure. For brevity, details are not elaborated herein again.

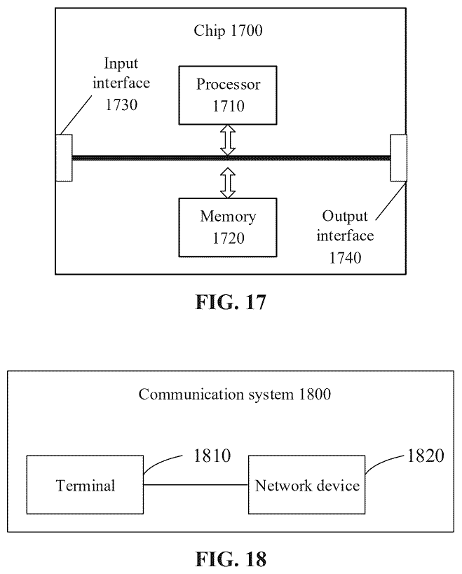

FIG. 17 is a schematic structural diagram of a chip according to an embodiment of the present disclosure. The chip 1700 illustrated in FIG. 17 includes a processor 1710. The processor 1710 may be configured to call a computer program stored in a memory, and run the computer program to perform each of the methods according to the embodiments of the present disclosure.

Optionally, as illustrated in FIG. 17, the chip 1700 may further include a memory 1720. The processor 1710 may be configured to call the computer program from the memory 1720, and run the computer program to perform each of the methods according to the embodiments of the present disclosure.

Herein, the memory 1720 may be a separate device independent of the processor 1710, or may be integrated into the processor 1710.

Optionally, the chip 1700 may further include an input interface 1730. Herein, the processor 1710 may control the input interface 1730 to communicate with other devices or chips, specifically, to obtain information or data from other devices or chips.

Optionally, the chip 1700 may further include an output interface 1740. Herein, the processor 1710 may control the output interface 1740 to communicate with other devices or chips, specifically, to output information or data to other devices or chips.

Optionally, the chip may be applied to the network device in the embodiments of the present disclosure. The chip may perform the corresponding process implemented by the network device in each of the methods in the embodiments of the present disclosure. For brevity, details are not elaborated herein again.

Optionally, the chip may be applied to the mobile terminal/terminal in the embodiments of the present disclosure. The chip may perform the corresponding process implemented by the mobile terminal/terminal in each of the methods in the embodiments of the present disclosure. For brevity, details are not elaborated herein again.

It should be understood that, the chip mentioned in the embodiments of the present disclosure may also be referred to as a system-level chip, a system chip, a chip system or a chip of a system-on-chip, etc.

FIG. 18 is a schematic block diagram of a communication system 1800 provided in an embodiment of the present disclosure. As illustrated in FIG. 18, the communication system 1800 includes a terminal 1810 and a network device 1820.

Herein, the terminal 1810 may be configured to implement corresponding functions that are implemented by the terminal of each of the aforementioned methods. The network device 1820 may be configured to implement corresponding functions that are implemented by the network device of each of the aforementioned above methods. For brevity, details are not elaborated herein again.

It should be understood that, the processor in the embodiments of the present disclosure may be an integrated circuit chip having a signal processing capability. During implementation, the steps of the foregoing method embodiments may be implemented by using an integrated logic circuit in a hardware form in the processor or implemented by using instructions in a software form. The foregoing processor may be a general purpose processor, a digital signal processor (DSP), an application-specific integrated circuit (ASIC), a field programmable gate array (FPGA), or another programmable logical device, discrete gate or transistor logical device, or discrete hardware component. The processor may be configured to implement or perform methods, operations and logical blocks disclosed in the embodiments of the present disclosure. The general-purpose processor may be a microprocessor, or the processor may be any conventional processor and the like. Operations of the methods disclosed with reference to the embodiments of the present disclosure may be directly executed and completed by means of a hardware decoding processor, or may be executed and completed by using a combination of hardware and software module in the decoding processor. The software module may be located in a mature storage medium in the field, such as a random access memory (RAM), a flash memory, a read-only memory (ROM), a programmable ROM (PROM), an electrically-erasable programmable memory, or a register. The storage medium is located in the memory, and the processor reads information in the memory to complete the operations in the foregoing methods in combination with hardware of the processor.

It can be understood that, the memory in the embodiments of the present disclosure may be a volatile memory or a non-volatile memory, or may include both a volatile memory and a non-volatile memory. The non-volatile memory may be an ROM, a PROM, an erasable PROM (EPROM), an electrically EPROM (EEPROM) or a flash memory. The volatile memory may be an RAM and is used as an external cache. By way of illustration, but not limitation, many forms of RAMs may be used, for example, a static RAM (SRAM), a dynamic RAM (DRAM), a synchronous DDRAM (SDRAM), a double data rate SDRAM (DDR SDRAM), an enhanced SDRAM (ESDRAM), a synchlink DRAM (SLDRAM) and a direct rambus RAM (DR RAM). It should be noted that, the memory in the system and method described herein is intended to include, but not be limited to, these memories and any other suitable types of memories.

It should be understood that, the foregoing memory is described only exemplarily rather than limitedly, for example, the memory in the embodiments of the present disclosure may be an SRAM, a DRAM, an SDRAM, a DDR SDRAM, an ESDRAM, an SLDRAM and a DR RAM, etc. It should be noted that, the memory in the embodiments of the present disclosure is intended to include, but not limited to, these memories and any other suitable types of memories.

An embodiment of the present disclosure further provides a computer-readable storage medium configured to store a computer program.

Optionally, the computer-readable storage medium may be applied to the network device in the embodiments of the present disclosure, and the computer program is executed to enable a computer to perform the corresponding process implemented by the network device in each of the methods of the embodiments of the present disclosure. For brevity, details are not elaborated herein again.

Optionally, the computer-readable storage medium may be applied to the mobile terminal/terminal in the embodiments of the present disclosure, and the computer program executed to enable a computer to perform the corresponding process implemented by the mobile terminal/terminal in each of the methods in the embodiments of the present disclosure. For brevity, details are not elaborated herein again.

An embodiment of the present disclosure further provides a computer program product including a computer program.

Optionally, the computer program product may be applied to the network device in the embodiments of the present disclosure, and the computer program instructions are executed to enable a computer to perform the corresponding process implemented by the network device in each of the methods in the embodiments of the present disclosure. For brevity, details are not elaborated herein again.

Optionally, the computer program product may be applied to the mobile terminal/terminal in the embodiments of the present disclosure, and the computer programs are executed to enable a computer to perform the corresponding process implemented by the mobile terminal/terminal in each of the methods of the embodiments of the present disclosure. For brevity, details are not elaborated herein again.

An embodiment of the present disclosure further provides a computer program.

Optionally, the computer program may be applied to the network device in the embodiments of the present disclosure, when the computer program is run by a computer, the computer program enables the computer to perform the corresponding process implemented by the network device in each of the methods of the embodiments of the present disclosure. For brevity, details are not elaborated herein again.

Optionally, the computer program may be applied to the mobile terminal/terminal in the embodiments of the present disclosure, when the computer program is run by a computer, the computer program enables the computer to perform the corresponding process implemented by the mobile terminal/terminal in each of the methods of the embodiments of the present disclosure. For brevity, details are not elaborated herein again.

Those of ordinary skill in the art may be aware that units and algorithm steps of each examples described in combination with the embodiments disclosed herein may be implemented by electronic hardware, or a combination of computer software and electronic hardware. Whether the functions are executed in hardware or software depends on specific applications and design constraints of the technical solutions. Professionals may use different methods to implement the described functions for each specific application, and such implementations shall not be regarded as outside the scope of the present disclosure.

Those skilled in the art may clearly understand that, for the specific working processes of the systems, apparatuses and units described above, reference may be made to the corresponding processes in the aforementioned method embodiments, and the specific working processes of the systems, devices and units will not be repeated herein for convenient and brief description.

In the several embodiments provided in this disclosure, it should be understood that the disclosed systems, apparatuses, and methods may be implemented in other manners. For example, the described apparatus embodiments are merely exemplary. For example, the unit division is merely a kind of logical function division, and other division manners may be adopted during practical implementation. For example, multiple units or components may be combined or integrated into another system, or some characteristics may be neglected or not executed. In addition, coupling or direct coupling or communication connection between various displayed or discussed components may be indirect coupling or communication connection, implemented through some interfaces, of the devices or the units, and may be electrical, mechanical, or in other forms.

The units described as separate components may or may not be physically separated, and the components displayed as units may or may not be physical units, that is, may be located in the same place, or may also be distributed to multiple network units. Part or all of the units may be selected to achieve the purpose of the solutions of the embodiments according to practical requirements.

In addition, various functional units in various embodiments of the present disclosure may be integrated into a processing unit, or each functional unit may physically exist independently, or two or more than two functional units may be integrated into a unit.

When the functions are implemented in form of a software functional module and sold or used as an independent product, the functions may be stored in a computer-readable storage medium. Based on such understanding, the essential part of the technical solutions of the present disclosure or a part of the technical solutions that contributes to the related art or a part of the technical solutions can be embodied in a form of a software product. The computer software product is stored in a storage medium and includes several instructions to enable a computer device (which may be a personal computer, a server, or a network device, etc.) to execute all or part of the operations of the methods in various embodiments of the present disclosure. The forgoing storage medium includes various media that can store program codes, such as a USB disk, a mobile hard disk, a ROM, a RAM, a magnetic disk, an optical disk, or the like.

The foregoing descriptions are merely specific implementations of present disclosure, but are not intended to limit the scope of protection of present disclosure. Variations or replacements which can be readily thought by those skilled in the art within the technical scope disclosed in the present disclosure shall fall within the scope of protection of the present disclosure. Therefore, the scope of protection of the present disclosure shall be subject to the scope of protection of the claims.

1. A communication method, comprising:
receiving, by a terminal, a trigger command from a network device, and transmitting, by the terminal, data to the network device, the trigger command being used to trigger the terminal to report the data;
wherein the trigger command is transmitted based on a beam sweeping manner, and/or the data is transmitted based on a first manner and/or a second manner, wherein the first manner is that, the terminal, after receiving the trigger command, selects a first time interval from a plurality of time intervals, and transmits the data after a delay of the first time interval; and the second manner is that, the terminal, after receiving the trigger command, selects a first uplink resource from a plurality of uplink resources, and transmits the data by using the first uplink resource.

2. The method of claim 1, wherein the trigger command is transmitted on different beams based on a second time interval;
wherein the trigger command carries a beam index used to indicate a beam in which the trigger command is located;
wherein the data carries a beam index used to indicate a beam in which the terminal is located.

3. The method of claim 1, further comprising:
obtaining, by the terminal, first configuration information, the first configuration information being used to configure the plurality of time intervals; wherein the first configuration information is configured by the network device; or, the first configuration information is local configuration information of the terminal;
wherein selecting the first time interval from the plurality of time intervals comprises:
selecting, by the terminal, the first time interval from the plurality of time intervals based on implementation of the terminal; or
selecting, by the terminal, the first time interval from the plurality of time intervals based on an indication from the network device;
wherein selecting, by the terminal, the first time interval from the plurality of time intervals based on the implementation of the terminal comprises:
randomly selecting, by the terminal, a time interval from the plurality of time intervals as the first time interval; or
selecting, by the terminal based on an identification of the terminal, a time interval from the plurality of time intervals as the first time interval;
or,
wherein selecting, by the terminal, the first time interval from the plurality of time intervals based on the indication from the network device comprises:
receiving, by the terminal, first indication information from the network device, the first indication information being used to indicate the first time interval among the plurality of time intervals; and
determining, by the terminal, the first time interval based on the first indication information.

4. The method of claim 1, wherein
the plurality of uplink resources are a plurality of sub-channels, and the plurality of sub-channels are partitioned from a spectrum supported by a cell in frequency domain; or
the plurality of uplink resources are time-division multiplexed, and/or frequency-division multiplexed, and/or code-division multiplexed, and/or space-division multiplexed.

5. The method of claim 1, further comprising:
obtaining, by the terminal, second configuration information, the second configuration information being used to configure the plurality of uplink resources;
wherein the second configuration information is configured by the network device; or, the second configuration information is local configuration information of the terminal;
wherein the plurality of uplink resources are distributed in a plurality of uplink resource groups, and the plurality of uplink resource groups are distributed periodically.

6. The method of claim 5, wherein the second configuration information comprises at least one of:
first information, used to determine a period of the plurality of uplink resource groups;
second information, used to determine a number of groups of the plurality of uplink resource groups;
third information, used to determine time-domain information of an uplink resource in an uplink resource group;
fourth information, used to determine frequency-domain information of an uplink resource in an uplink resource group;
fifth information, used to determine code-domain information of an uplink resource in an uplink resource group; or
sixth information, used to determine space-domain information of an uplink resource in an uplink resource group;
wherein the third information comprises at least one of:
a first parameter, used to indicate a time-domain starting position of a first uplink resource in the uplink resource group;
a second parameter, used to indicate a time-domain length of a first uplink resource in the uplink resource group;
a third parameter, used to indicate a time-domain length of an interval between two adjacent uplink resources in time domain of the uplink resource group; or
a fourth parameter, used to indicate a number of uplink resources in time domain of the uplink resource group;
wherein the fourth information comprises at least one of:
a fifth parameter, used to indicate a frequency-domain starting position of a first uplink resource in the uplink resource group;
a sixth parameter, used to indicate a frequency-domain length of a first uplink resource in the uplink resource group;
a seventh parameter, used to indicate a frequency-domain length of an interval between two adjacent uplink resources in frequency domain of the uplink resource group; or
an eighth parameter, used to indicate a number of uplink resources in frequency domain of the uplink resource group.

7. The method of claim 5, wherein selecting the first uplink resource from the plurality of uplink resources comprises:
randomly selecting, by the terminal, an uplink resource from the plurality of uplink resource groups as the first uplink resource; or
selecting, by the terminal based on an identification of the terminal, an uplink resource from the plurality of uplink resource groups as the first uplink resource;
wherein in a case that independent resource index spaces are used by different uplink resource groups in the plurality of uplink resource groups, selecting, by the terminal based on the identification of the terminal, the uplink resource from the plurality of uplink resource groups as the first uplink resource comprises:
determining, by the terminal, a first resource group index based on the identification of the terminal and a number of groups of the plurality of uplink resource groups, and determining, by the terminal, a first resource index based on the identification of the terminal and a number of uplink resources in an uplink resource group; and
determining, by the terminal, the first uplink resource based on the first resource group index and the first resource index;
wherein in a case that a unified resource index space is used by different uplink resource groups in the plurality of uplink resource groups, selecting, by the terminal based on the identification of the terminal, the uplink resource from the plurality of uplink resource groups as the first uplink resource comprises:
determining, by the terminal, a first resource index based on the identification of the terminal and a number of resources in the plurality of uplink resource groups; and
determining, by the terminal, the first uplink resource based on the first resource index.

8. The method of claim 1, wherein
the first uplink resource comprises a first portion and a second portion, wherein the first portion is used to transmit a first sequence, and the second portion is used to transmit the data; or
the first uplink resource has an association relationship with a first associated resource, wherein the first associated resource is used to transmit a first sequence, and the first uplink resource is used to transmit the data;
wherein the method further comprises:
obtaining, by the terminal, third configuration information, the third configuration information being used to configure a sequence at a cell level or configure a sequence at a beam level; wherein in a case that the third configuration information is used to configure the sequence at the beam level, different beam indexes are associated with different sequence ranges;
selecting, by the terminal based on a beam index carried in the trigger command and the third configuration information, the first sequence from a sequence range associated with the beam index; and
when determining, by the terminal, that reception of the data fails, retransmitting, by the terminal, the data to the network device;
wherein determining, by the terminal, that the reception of the data fails comprises:
receiving, by the terminal, a failure reception response message from the network device, the failure reception response message being used to indicate a sequence index corresponding to the data that is failed to be received; and determining, by the terminal, that the reception of the data fails based on the failure reception response message;
or,
when not receiving, by the terminal, response message of the data from the network device during a first period, determining, by the terminal, that the reception of the data fails; wherein the first period is a running period of a first timer, and a starting time of the first timer is determined based on a time for transmitting the data.

9. The method of claim 1, wherein the terminal is a zero-power terminal, or a passive Internet of things terminal, or an Internet of things terminal based on ambient energy.

10. A terminal, comprising a processor and a memory for storing a computer program, wherein the processor is configured to call and run the computer program stored in the memory, to cause the terminal to perform:
receiving a trigger command from a network device, and transmitting data to the network device, the trigger command being used to trigger the terminal to report the data;
wherein the trigger command is transmitted based on a beam sweeping manner, and/or the data is transmitted based on a first manner and/or a second manner, wherein the first manner is that, the terminal, after receiving the trigger command, selects a first time interval from a plurality of time intervals, and transmits the data after a delay of the first time interval; and the second manner is that, the terminal, after receiving the trigger command, selects a first uplink resource from a plurality of uplink resources, and transmits the data by using the first uplink resource.

11. The terminal of claim 10, wherein the trigger command is transmitted on different beams based on a second time interval;
wherein the trigger command carries a beam index used to indicate a beam in which the trigger command is located;
wherein the data carries a beam index used to indicate a beam in which the terminal is located.

12. The terminal of claim 10, wherein the processor is further configured to call and run the computer program stored in the memory to cause the terminal to perform:
obtaining first configuration information, the first configuration information being used to configure the plurality of time intervals; wherein the first configuration information is configured by the network device; or, the first configuration information is local configuration information of the terminal;
wherein in selecting the first time interval from the plurality of time intervals, the processor is configured to call and run the computer program stored in the memory to cause the terminal to specifically perform:
selecting the first time interval from the plurality of time intervals based on implementation of the terminal; or
selecting the first time interval from the plurality of time intervals based on an indication from the network device;
wherein in selecting the first time interval from the plurality of time intervals based on the implementation of the terminal, the processor is configured to call and run the computer program stored in the memory to cause the terminal to specifically perform:
randomly selecting a time interval from the plurality of time intervals as the first time interval; or
selecting, based on an identification of the terminal, a time interval from the plurality of time intervals as the first time interval;
or,
wherein in selecting the first time interval from the plurality of time intervals based on the indication from the network device, the processor is configured to call and run the computer program stored in the memory to cause the terminal to specifically perform:
receiving first indication information from the network device, the first indication information being used to indicate the first time interval among the plurality of time intervals; and
determining the first time interval based on the first indication information.

13. The terminal of claim 10, wherein
the plurality of uplink resources are a plurality of sub-channels, and the plurality of sub-channels are partitioned from a spectrum supported by a cell in frequency domain; or
the plurality of uplink resources are time-division multiplexed, and/or frequency-division multiplexed, and/or code-division multiplexed, and/or space-division multiplexed.

14. The terminal of claim 10, wherein the processor is further configured to call and run the computer program stored in the memory to cause the terminal to perform:
obtaining second configuration information, the second configuration information being used to configure the plurality of uplink resources;
wherein the second configuration information is configured by the network device; or, the second configuration information is local configuration information of the terminal;
wherein the plurality of uplink resources are distributed in a plurality of uplink resource groups, and the plurality of uplink resource groups are distributed periodically.

15. The terminal of claim 14, wherein the second configuration information comprises at least one of:
first information, used to determine a period of the plurality of uplink resource groups;
second information, used to determine a number of groups of the plurality of uplink resource groups;
third information, used to determine time-domain information of an uplink resource in an uplink resource group;
fourth information, used to determine frequency-domain information of an uplink resource in an uplink resource group;
fifth information, used to determine code-domain information of an uplink resource in an uplink resource group; or
sixth information, used to determine space-domain information of an uplink resource in an uplink resource group;
wherein the third information comprises at least one of:
a first parameter, used to indicate a time-domain starting position of a first uplink resource in the uplink resource group;
a second parameter, used to indicate a time-domain length of a first uplink resource in the uplink resource group;
a third parameter, used to indicate a time-domain length of an interval between two adjacent uplink resources in time domain of the uplink resource group; or
a fourth parameter, used to indicate a number of uplink resources in time domain of the uplink resource group;
wherein the fourth information comprises at least one of:
a fifth parameter, used to indicate a frequency-domain starting position of a first uplink resource in the uplink resource group;
a sixth parameter, used to indicate a frequency-domain length of a first uplink resource in the uplink resource group;
a seventh parameter, used to indicate a frequency-domain length of an interval between two adjacent uplink resources in frequency domain of the uplink resource group; or
an eighth parameter, used to indicate a number of uplink resources in frequency domain of the uplink resource group.

16. The terminal of claim 14, wherein in selecting the first time interval from the plurality of time intervals, the processor is configured to call and run the computer program stored in the memory to cause the terminal to specifically perform:
randomly selecting an uplink resource from the plurality of uplink resource groups as the first uplink resource; or
selecting, based on an identification of the terminal, an uplink resource from the plurality of uplink resource groups as the first uplink resource;
wherein in a case that independent resource index spaces are used by different uplink resource groups in the plurality of uplink resource groups, the processor is configured to call and run the computer program stored in the memory to cause the terminal to specifically perform:
determining a first resource group index based on the identification of the terminal and a number of groups of the plurality of uplink resource groups, and determining a first resource index based on the identification of the terminal and a number of uplink resources in an uplink resource group; and
determining the first uplink resource based on the first resource group index and the first resource index;
wherein in a case that a unified resource index space is used by different uplink resource groups in the plurality of uplink resource groups, the processor is configured to call and run the computer program stored in the memory to cause the terminal to specifically perform:
determining a first resource index based on the identification of the terminal and a number of resources in the plurality of uplink resource groups; and
determining the first uplink resource based on the first resource index.

17. The terminal of claim 10, wherein
the first uplink resource comprises a first portion and a second portion, wherein the first portion is used to transmit a first sequence, and the second portion is used to transmit the data; or
the first uplink resource has an association relationship with a first associated resource, wherein the first associated resource is used to transmit a first sequence, and the first uplink resource is used to transmit the data;
wherein the processor is further configured to call and run the computer program stored in the memory to cause the terminal to perform:
obtaining third configuration information, the third configuration information being used to configure a sequence at a cell level or configure a sequence at a beam level; wherein in a case that the third configuration information is used to configure the sequence at the beam level, different beam indexes are associated with different sequence ranges;
selecting, based on a beam index carried in the trigger command and the third configuration information, the first sequence from a sequence range associated with the beam index; and
when determining that reception of the data fails, retransmitting the data to the network device;
wherein in determining that the reception of the data fails, the processor is configured to call and run the computer program stored in the memory to cause the terminal to specifically perform:
receiving a failure reception response message from the network device, the failure reception response message being used to indicate a sequence index corresponding to the data that is failed to be received; and determining that the reception of the data fails based on the failure reception response message;
or,
when not receiving response message of the data from the network device during a first period, determining that the reception of the data fails; wherein the first period is a running period of a first timer, and a starting time of the first timer is determined based on a time for transmitting the data.

18. The terminal of claim 10, wherein the terminal is a zero-power terminal, or a passive Internet of things terminal, or an Internet of things terminal based on ambient energy.

19. A network device, comprising a processor and a memory for storing a computer program, wherein the processor is configured to call and run the computer program stored in the memory, to cause the network device to perform:
transmitting a trigger command, and receiving data from a terminal, the trigger command being used to trigger the terminal to report the data;
wherein the trigger command is transmitted based on a beam sweeping manner, and/or the data is transmitted based on a first manner and/or a second manner, wherein the first manner is that, the terminal, after receiving the trigger command, selects a first time interval from a plurality of time intervals, and transmits the data after a delay of the first time interval; and the second manner is that, the terminal, after receiving the trigger command, selects a first uplink resource from a plurality of uplink resources, and transmits the data by using the first uplink resource.

20. The network device of claim 19, wherein the trigger command is transmitted on different beams based on a second time interval;
wherein the trigger command carries a beam index used to indicate a beam in which the trigger command is located;
wherein the data carries a beam index used to indicate a beam in which the terminal is located.
